(19) United States
(12) Patent Application Publication
(10) Pub. No.: US 2006/0286360 A1
(43) Pub. Date: Dec. 21, 2006

(54) Hybrid Organic-Inorganic Materials and Methods of Preparing the Same

(75) Inventors: Wendell E. Rhine, Belmont, MA (US); Duan Li Ou, Northborough, MA (US); Jong Ho Sonn, Worcester, MA (US)

Correspondence Address: ASPEN AEROGELS INC.;IP DEPARTMENT, 30 FORBES ROAD, BLDG. B, NORTHBOROUGH, MA, 01532, US

(73) Assignee: Aspen Aerogels Inc., Northborough, MA (US)

(21) Appl. No.: 11/425,351

(22) Filed: Jun. 20, 2006

Related U.S. Application Data
(60) Provisional application No. 60/696,867, filed on Jul. 6, 2005.
(60) Provisional application No. 60/692,100, filed on Jun. 20, 2005.

(51) Int. Cl. E04B 1/74; A01K 1/015

(52) U.S. Cl. 428/221; 252/62

(57) ABSTRACT

Embodiments of the present invention describe hybrid organic-inorganic aerogel materials wherein a variety of organic components are incorporated into the aerogel. Methods provided herein allow functionalization and or reinforcement of aerogels starting with urea or urethane formation reactions, gelation with inorganic precursors and subsequent drying thereof.

### CROSS REFERENCES TO RELATED APPLICATIONS

This application claims the benefit of priority to U.S. Provisional application 60/696,867 filed Jul. 6, 2005 and 60/692,100 filed Jun. 20, 2005; both are hereby incorporated by reference as if fully set forth.

### STATEMENT REGARDING FEDERALLY SPONSORED RESEARCH OR DEVELOPMENT

This invention was partially made with Government support under Contract NNM04AA79C awarded by the National Aeronautics and Space Administration (NASA.) The Government has certain rights in parts of this invention.

### SUMMARY OF THE INVENTION

Embodiments of the present invention describe hybrid aerogels comprising inorganic and organic components. The introduction of the organic component may serve as mechanical reinforcement, chemical functionality or both. Various methods for preparing such hybrid materials are described. One method involves the steps of: reacting a first organoalkoxysilane having at least one isocyanate reactive group with a second organoalkoxysilane having at least one reactive amine group or hydroxyl group, such that a urea or urethane group respectively is formed linking both said first and second organoalkoxysilane and resulting in a urea bridged compound. The said first, second or both organoalkoxysilanes comprise at least one organic component other than a urea or amine; or where urethane is formed one organic component other than a hydroxyl or a urethane group. Subsequently the urea or urethane bridged compound is reacted with a metal oxide precursor (such as silica) thereby forming a gel network with said organic component covalently bonded therein. Upon drying a hybrid aerogel material is formed with improved mechanical properties, more chemical functionalities or both.

Metal oxide gel precursors for silica gel formation are exemplified by: alkylalkoxysilane, ethylpolysilicate, partially tetraethylorthosilicate (TEOS), tetramethylorthosilicate (TMOS), partially hydrolyzed TEOS, partially hydrolyzed TMOS or a combination thereof. In a preferred case, the organoalkoxysilanes are organotrialkoxysilanes, more preferably organotriethoxysilanes.

Examples of urea bridged compound include tolylene 2,4 di-ureapropyltriethoxysilane, 4,4 methylene bis(phenylureapropyltriethoxysilane), 1,6-di(triethoxypropylrea)-hexane, isophorone-di(triethoxypropylurea) or tolylene 2,4 di-(triethoxysilylpropylurea). In general the organic component may be of the class olefins, aliphatics, arylenics, acetylenics, organometallics, coordination compounds or a combination thereof. The hybrid aerogels may be reinforced with a fibrous structure comprising microfibers, mats, felts, woven fabrics, non-woven fabrics, fibrous battings, lofty battings or a combination thereof. Furthermore, addictives such as organic or inorganic fillers, antioxidants, fibers, IR opacifiers, or combinations thereof are incorporated into the gel before drying thereof. Suitable IR opacifiers include: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide, chromium oxide, silicon carbide and any combination thereof. The percent composition the urea bridged or urethane bridge compounds may be greater than 10% or greater than 40%, by weight relative to the final aerogel material. Thermal conductivity of the aerogel materials prepared thusly is less than 20 mW/mK, less than 15 mW/mK or less than 10 mW/mK at room temperature and ambient pressure. Flexural modulus of such materials can be greater than about 480 psi. Densities are less than 0.3 g/cm³ more preferably less than 1.0 g/cm³; Average pore size for these hybrid aerogels in one embodiment greater than or equal to about 14 nm; in another embodiment, surface areas of the aerogel material is greater than about 791 m²/g.

### BRIEF DESCRIPTION OF THE DRAWINGS

FIG. 1 shows the temperatures as measured between the two layers of aerogel wrapped around a container of liquid nitrogen, where the cold side temperature was −180° C.

### DESCRIPTION

Aerogels are among the best known insulating materials today. Within the context of embodiments of the present invention “aerogels” or “aerogel materials” along with their respective singular forms, refer to gels containing air as a dispersion medium in a broad sense, and refer to gel materials dried via supercritical fluids in a narrow sense. Most often, aerogel materials are prepared from silica precursors resulting in a porous silicate network. However, this low density inorganic structure (often >90% air) has certain mechanical limitations such as stiffness and brittleness among others etc. As such, improvement of mechanical properties is of interest. Also of interest is the high internal volume of aerogels which is considered suitable for catalysis-related applications and the like. Unfortunately, very few adequate methodologies exist for functionalization and/or mechanical improvement of aerogel materials. In one aspect, embodiments of the present invention describe aerogel materials based on inorganic compounds with reinforcing organic components. In another aspect, embodiments of the present invention describe aerogel materials based on inorganic compounds with organic functional groups covalently bonded therein. In a further aspect, embodiments of the present invention describe aerogel materials with hybrid organic-inorganic structures wherein the organic component is bonded on at least two ends or at least three ends to the inorganic network. Such alterations in the aerogel structure provide: a) better mechanical performance, b) a variety of organic chemical functionalities covalently bonded therein or c) both.

The hybrid aerogels described can show lower thermal conductivities and a higher flexural modulus than pure silica aerogels. Ureasils described presently have a relatively low molecular weight. One benefit here is the potential for preparing hybrid materials with relatively high cross-link densities. This provides added mechanical performance and enables application in additional areas previously excluded to silica aerogels.

Aerogels with improved mechanical properties are highly desirable for various industries where the insulation is reusable and cost effective. The space industry for instance requires reusable, safe, reliable, lightweight and cost effective components in launch vehicles and spacecraft. This being particularly the case with reusable launch vehicles (RLVs) designed to reduce the cost of access to space thereby promoting creation and delivery of new space services and other activities that can strengthen economic competitiveness. A target area for furthering this technology lies in design and development of reusable integrated insulation systems comprising lightweight composite materials. For example, current cryogenic tank insulation materials provide sufficient thermal performance but are far from optimizing weight reduction and are thus not stable enough for integration into RLVs. Examples of these materials are organic foams based on polyetherimide, polyurethane, polyimide and other such polymers. The hybrid materials of the present invention would provide significant weight reduction over the previously mentioned foams while providing equal, if not better thermal performance. Due to their thermal stability said hybrid materials present excellent candidates for RLVs functioning as insulation for cryogenic fuel (Liquid H₂, O₂, etc.) tanks.

The hybrid materials of the present invention comprise organic components such as aliphatic, olefinic, aromatic or organometallic or a combination thereof. In general these components are characterized by a molecular weights less than about 1000 g/mol, preferably less than about 700 g/mol and even more preferably less than about 450 g/mol. Alternatively said organic components are characterized by principal carbon chain lengths of: less than about 20 carbons, more preferably less than about 15 carbons and even more preferably less than 10 carbons.

It is important to note that published U.S. patent applications US2005/0192367A1 and US2005/0192366A1 both disclose reinforcement of silica aerogels with polymers. Obviously, these reinforcement systems are mechanistically different from the present concept in that a relatively shorter organic molecule can be expected to perform differently (under tensile forces along the length of the chain) than a long polymer which, and not wishing to be bound by theory may need to go through conformational changes before being fully elongated. Also, and again without being limited to theory, with shorter organic components, more integration thereof with the silica network can be expected since the much larger polymers can experience more steric hindrance to accessing reactive sites. In addition to mechanical improvements, the present invention also provides methods by which a variety of organic moieties are incorporated into a silica network.

Gel materials can be prepared in a variety of ways. In this description, special focus is directed to the sol gel method while recognizing that other methods are also available for use herein. In a classic view, the sol-gel method involves polymerizing a colloidal suspension (sol) containing the gel precursor materials thereby forming a gel. The sol gel method is also described in further detail in Brinker C. J., and Scherer G. W., Sol-Gel Science; New York: Academic Press, 1990 hereby incorporated by reference.

In general, the gel precursors can comprise an inorganic, organic or hybrid inorganic/organic materials. The inorganic materials can comprise zirconia, yttria, hafnia, alumina, titania, ceria, and silica, magnesium oxide, calcium oxide, magnesium fluoride, calcium fluoride, or any combinations thereof. Organic precursors can comprise polyacrylates, polymethacrylates, polyolefins, polystyrenes, polyacrylonitriles, polyurethanes, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, agarose and any combinations of the above. Specific examples of silica gel precursors include but are not limited to: ethylpolysilicates, tetraethylorthosilicate (TEOS), teteramethylorthosilicate (TMOS), hydrolyzed or partially hydrolyzed forms thereof or any combination thereof, Still further examples include silica chlorides, and sodium silicates.

According to embodiments of the present invention, a variety of organic components can be incorporated into an aerogel structure. Some examples are: olefinic, aliphatic (including cyclic aliphatics), arylenic, acetylenic, organometallic and coordination compounds. The general reaction representing the incorporation of such organic components, by way of a non-limiting example into a silica gel is as follows:
(RO)₃—Si—R₂—Si—(OR₁)₃+—[(R₃₀)ₓSiO_{(4-x)/2}]—---->Gel
Where (x) can range from 0-4 and (n) represents the average length of the silica polymer, oligomer or monomer. R and R₁ are usually ethyl or methyl groups but can be alkyl chains of higher length (preferably 1 to 12), different branching structure, various organic functionalities, different saturations or any combination thereof. Preferably R and R₁ are the same. R₂, an organic component as described throughout this description, can belong to essentially any class of organic compounds described previously as being olefinic, aliphatic, arylenic, acetylenic, organometallic, coordination compound, or any combination thereof. Preferably R₂ comprises a urea or urethane linkage. R₃ is an alkyl chain having a length preferably 1 to 12 carbon atoms and can have different branching structure, various organic functionalities, different saturations or any combination thereof.

In a special embodiment of the present invention, various metal oxides can be used to prepare the hybrid materials. A generalized reaction is illustrated below where (M) and (M₁) are metals or semi-metal such as Germanium. (M₂) can be a whole host of elements capable of forming metal oxides suitable for sol-gel chemistry (See Brinker C. J., and Scherer G. W., Sol-Gel Science; New York: Academic Press, 1990 for a more detailed discussion.) As a non-limiting example, these elements can be: Zr, Ti, Al, Mg, Yt, Hf, Ce, Ca. The rest of the symbols (R₁, R₂, R₃, x, n) can be defined according to the previous example.
(RO)₃-M-R₂-M₁-(OR₁)₃+—[(R₃O)ₓM₂O_{(4-x)/2}]ₙ—---->Gel

In yet another special embodiment, an organoalkoxysilane is attached to the gel network after gelation has taken place. For example, this can be achieved by forming a wet gel (gel with solvent filled pores) from a gel precursor and subsequently adding stoicheometric or excess amounts of an organoalkoxysilane compound capable of reacting with said gel precursor to form a chemical bond. Gelling may be induced by adding a catalyst, changing the pH of the solution (i.e. adding base or acid), by applying heat or an electromagnetic energy (e.g. IR, UV, X-ray, microwave, gamma ray, acoustic energy, ultrasound energy, particle beam energy, electron beam energy, beta particle energy, alpha particle energy, etc), or a combination thereof. Gel formation may be viewed as the point where a solution (or mixture) comprising gel precursors exhibits resistance to flow and/or forms a continuous polymeric network throughout its volume.

In an embodiment of the present invention, functionalized aerogels are prepared by reacting an organic-bridged alkoxysilane comprising a urea linkage (“ureasil”) with a silica precursor. The previously unexploited advantage of preparing an urea bridged alkoxysilane is that such compounds are relatively easy to prepare and most importantly, can serve as a vehicle for introducing a variety of complex organic compounds into inorganic aerogel (e.g. silica) network.

The reaction between a ureasil and a silica precursor follows the common path of sol-gel chemistry involving hydrolysis and condensation reactions as generalized below. The hydrolysis and condensation reactions can be acid or base catalyzed.

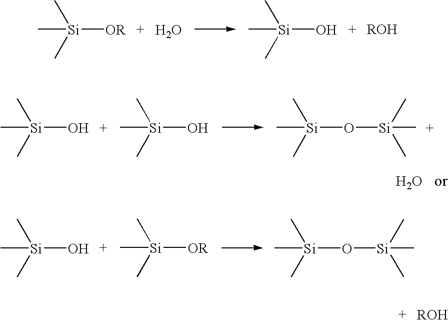

By way of a non-limiting example, preparation of an ureasil can be accomplished by reacting an organo trialkoxysilane comprising at least one reactive amine group with another organotrialkoxysilane comprising at least one isocyanate reactive group. Each of these reactants also comprises an organic component that is to be incorporated into the final aerogel structure. Preparation of these ureasil compounds can be carried out via the following exemplarily reaction:
(EtO)₃—Si-Q₁-NH+OCN-Q₂-Si-(EtO)₃-->(EtO)₃—Si-Q₁-NH—CO—NH-Q₂-Si-(EtO)₃
Another general example may be:
NH₂-Q₁-NH₂+2OCN-Q₂-Si—(OEt)₃---->(EtO)₃₋Si-Q₂-NH—CO—NH-Q₁-NH—CO—NH-Q₂-Si—(OEt)₃
Where Q₁ and Q₂ are the organic components that one would desire to incorporate into an aerogel structure. Reactions of the above products with a silica precursor yielding the hybrid gel materials of the present invention may be as follows:
(EtO)₃—Si-Q₁-NH—CO—NH-Q₂-Si-(EtO)₃+—[(R₃O)ₓSiO_{(4-x)/2}]ₙ—---->Gel
(EtO)₃₋Si-Q₂-NH—CO—NH-Q₁-NH—CO—NH-Q₂-Si—(OEt)₃+—[(R₃O)ₓSiO_{(4-x)/2}]ₙ—-->Gel
Where (x) can range from 0-4, (n) represents the average length of the silica polymer, oligomer or monomer as defined previously, and the same with R₃. A main aspect of this urethane reaction is that it too is a highly compatible reaction and can thus serve as another vehicle for introducing a variety of organic compounds into an aerogel.

According to the present embodiment, organic components represented by Q₁ and Q₂ above, may be of aliphatic, olefinic, arylenic, organometallic or a combination thereof. This can improve the aerogel material in a variety of areas such as structural morphology, mechanical performance and chemical functionality. Using the same reaction, various organic components including those listed in table 1 may be incorporated in an aerogel structure. The silica precursor for subsequent gelation can be obtained from a variety of vendors. Presently, TEOS or TMOS in sufficient amounts to promote gelation with the ureasil compounds is preferred. However, it should be noted that other oxides such as alumina can be used to replace silica as gel precursor materials.

In a related embodiment, incorporation of organic components within an aerogel material can be carried out using urethane linkages. That is, reacting an organic-bridged alkoxysilane comprising a urethane linkage with a silica precursor. As with the ureasil examples, this is accomplished is by reacting an organotrialkoxysilane comprising at least one reactive hydroxyl group, with another organotrialkoxysilane comprising at least one isocyanate reactive group. Each of these reactants also comprises an organic component that is to be incorporated into the final aerogel structure. One type of such reaction is exemplified below:
(EtO)₃—Si-Q₁-OH+OCN-Q₂-Si-(EtO)_{3 ---->}(EtO)₃—Si-Q₁-O—CO—NH-Q₂-Si-(EtO)₃

Another general reaction is as follows:
Q₁-OH+OCN-Q₂-Si-(EtO)₃-->Q₁-O—CO—NH-Q₂-Si-(EtO)₃

Where Q₁ and Q₂ are the organic components that one would desire to incorporate into an aerogel structure. The corresponding subsequent reaction thereof with a silica precursor to obtain the wet gel is as follows:
(EtO)₃—Si-Q₁-CO—O—NH-Q₂-Si-(EtO)₃+—[(R₃O)ₓSiO_{(4-x)/2}]ₙ—---->Gel
Q₁-O—CO—NH-Q₂-Si-(EtO)₃+—[(R₃O)ₓSiO_{(4-x)/2}]ₙ—---->Gel
Where (x) can range from 0-4, (n) represents the average length of the silica polymer, oligomer or monomer and R₃ is defined as in the above examples.

In another embodiment, organic compounds terminated with more than two metal-alkoxide end caps are employed. Such branched precursors can be commercially purchased or synthesized. An example is a commercially available product is 1,3,5-tri(triethoxysilyl)benzene, a urethane-bridged alkoxysilane. Other examples are shown in table 1. An example of preparing such organoalkoxysilanes is as follows:

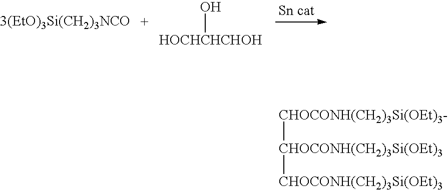

Table 1 includes an array of organic components that may be incorporated into the hybrid aerogel structures described presently.

TABLE 1
Characteristics of reactants

| | | | Molecular |
|---|---|---|---|
| Abbreviation | Name | Chemical Structure | weight |
| IPDI | Isophorone diisocyanate | 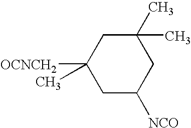 | 222.28 |
| MDI | Methylene bisphenyl diisocyanate | 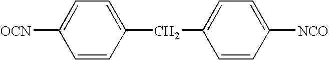 | 250.25 |
| TDI | Tolylene dusocyanate | 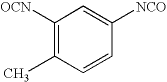 | 174.16 |
| γ-IPTES | 3-isocyanato- | OCN—(CH₂)₃Si(OC₂H₅)₃ | 247.37 |
| | propyltriethoxy-silane | | |
| γ-APTES | 3-aminopropyl- | H₂N—(CH₂)₃Si(OC₂H₅) | 221.37 |
| | triethoxysilane | | |
| AEAPTES | N-(2-aminoethyl)-3- | H₂NCH₂CH₂NH(CH₂)₃Si(OC₂H₅)₃ | 226.36 |
| | aminoproply- | | |
| | triethoxysilane | | |
| | N-(Hydroxyethyl)-N- methyamino- propyltrimethoxy- silane | 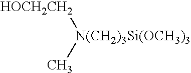 | 237.37 |
| | (3-glycidylpropyl) triethoxysilane | 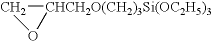 | 278.42 |
| | ethylene diamine 2HCl | H₂NCH₂CH₂NH₂ | 133.02 |
| | melamine | 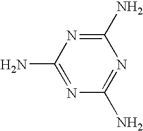 | 126.12 |
| | Guanidine HCl | 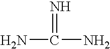 | 95.53 |
| | Benzenetetraamine- 4HCl | 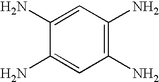 | 284.01 |
| | phenylenediamine | 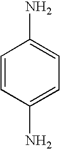 | 108.14 |
| | 1,5- Diaminonaphthalene | 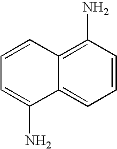 | 158.20 |
| | 1,8- Diaminonaphthalene | 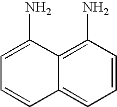 | 158.20 |
| | 2,3- Diaminonaphthalene | 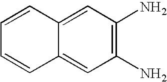 | 158.20 |
| | 2,7-Diaminofluorene | 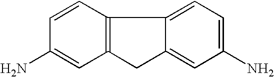 | 196.25 |
| | 1,3-Diaminopyrene | 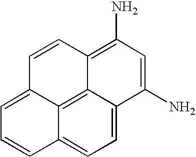 | 232.29 |
| | 1,6-Diaminopyrene | 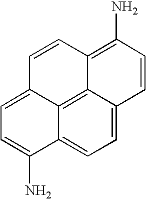 | 232.29 |
| | 1,8-Diaminopyrene | 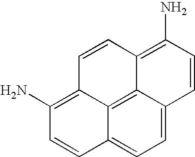 | 232.29 |
| | Benzidine | 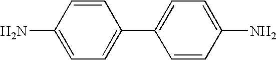 | 184.24 |
| | 3,3′Diaminobenzidine | 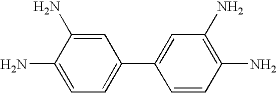 | 214.27 |
| | 2,2′,5,5′-Tetrachloro- Benzidine | 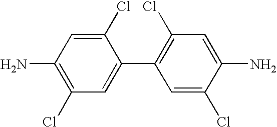 | 322.02 |
| | 3,6-Diaminocarbazole | 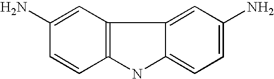 | 197.24 |
| EG | Ethylene glycol | HOCH₂CH₂OH | 62.07 |
| GLY | glycerol | 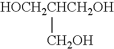 | 92.09 |
| | Pentaerythritol | 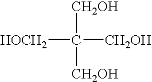 | 136.15 |
| | Resorcinol | 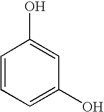 | 110.11 |
| | Phloroglucinol dihydrate | 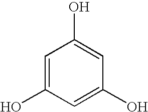 | 162.14 |
| | hydroquinone | 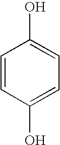 | 110.11 |

Examples of commercially available bis trialkoxysilyl functionalized molecules (GelEst)

| | | | |
|---|---|---|---|
| | Bis(triethoxysilyl)- | (C₂H₅O)₃SiCH₂Si(OC₂H₅)₃ | 340.56 |
| | methane | | |
| | Bis(triethoxysilyl) | (C₂H₅O)₃SiCH₂CH₂Si(OC₂H₅)₃ | 354.59 |
| | ethane | | |
| | Bis(triethoxysilyl) ethylene | 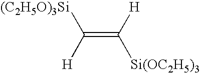 | 352.57 |
| BTESPA | Bis(triethoxysilyl- | (C₂H₅O)₃Si(CH₂)₃NH(CH₂)₃Si(OC₂H₅)₃ | 425.71 |
| | propyl) amine | | |
| | Bis(triethixysilyl | (C₂H₅O)₃Si(CH₂)₃S—S(CH₂)₃Si(OC₂H₅)₃ | 474.82 |
| | propyl) disulfide | | |
| BTSB | 1,4-bis (triethoxysilyl) benzene | 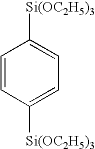 | 402.64 |
| | 1,2- Bis(timethoxysilyl) decane | 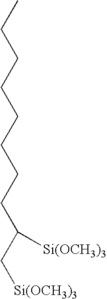 | 382.65 |
| | Bis(triethoxysilyl) | (C₂H₅O)₃Si(CH₂)₈Si(OC₂H₅)₃ | |
| | octane | | |

Examples of other bis trialkoxysilyl functionalized molecules

| | |
|---|---|
| 1,4- Bis(trialkoxylsilyl- methyl)benzene | 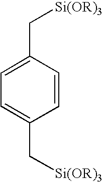 |
| 1,3- Bis(trialkoxylsilyl- methyl)benzene | 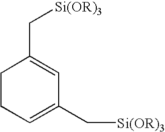 |
| 1,2- Bis(trialkoxylsilyl- methyl)benzene | 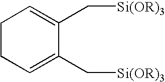 |
| 2,5- Bis(trialkoxylsilyl- methyl)-p-xylene | 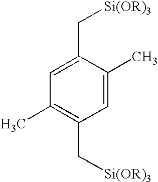 |
| 1,4- Bis(trialkoxylsilyl- methyl)durene | 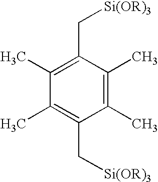 |
| 1,3,5-tri- (triethoxysilyl) benzene | 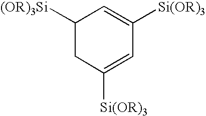 |
| 9,10- Bis(trialkoxylsilyl- methyl)anthracene | 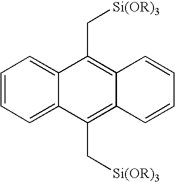 |
| 1,1′- Bis(trialkoxylsilyl- methyl)ferrocene | 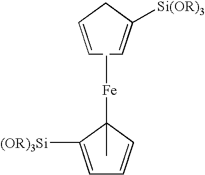 |

A review article by K. J. Shea and D. A. Loy (Chem. Mater. 2001, 13, 3306-3319), hereby incorporated by reference, may serve as an addendum to the compounds listed in table 1.

It is therefore highly noteworthy that a whole host of functional groups can be incorporated into an aerogel structure by using a urea or urethane formation reaction and subsequent gelation with a metal oxide precursor. Non-limiting examples of such functional groups are: ketones, amines (primary, secondary and teriary), ethers, thiol, esters, amids (primary, secondary, tertiary), alkanes, alkenes, alkynes, disulfides, diethers, anhydrides, ureas, carbamates, phenyls, phenyl derivatives and naphthyls, etc.

The gel formation reactions shown above depict formation of wet gels where upon appropriate drying result in aerogels. Drying plays an important role in engineering the properties of aerogels, such as porosity and density which in turn influence the material thermal conductivity. To date, numerous drying methods have been explored. U.S. Pat. No. 6,670,402 teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. Finally, U.S. Pat. No. 5,565,142 herein incorporated by reference describes subcritical drying techniques. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

In yet another embodiment, the present hybrid materials are reinforced with a fibrous structure comprising: microfibers, mats, felts, woven fabrics, non-woven fabrics, fibrous battings, lofty battings or a combination thereof. Aerogel composites reinforced with a fibrous batting, herein referred to as “blankets”, are particularly useful for applications requiring flexibility since they are highly conformable and do not significantly alter the thermal conductivity. Aerogel blankets and similar fiber-reinforced aerogel composites are described in published US patent application 2002/0094426A1 and U.S. Pat. Nos. 6,068,882; 5,789,075; 5,306,555; 6,887,563 and 6,080,475 all hereby incorporated by reference, in their entirety.

In another embodiment, opacifying compounds are incorporated into the final gel material at any point before drying. Such opacifiers include but are not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide and any combination thereof.

The resulting gel materials of the present invention can optionally be aged to promote further cross linkages in the gel network. Aging may involve, maintaining the wet gel at a quiescent state for extended periods of time, maintaining the gel at elevated temperatures, using a surface modifying compound such as hexamethyldisilazane (HMDZ) or any combination thereof to further strengthen the gel network.

A non-limiting example involving a ureasil and a silica precursor for preparing a hybrid gel material is as follows. To make the hybrid aerogel, 10 to 50 wt % bis[3-(triethoxysilyl)propyl]urea was added to an alcoholic solution of hydrolyzed silica precursor containing 20% SiO₂ by weight. After stirring for 15 min, an alcoholic solution containing water and NH₃ was added. The mixture was stirred for 5 min and then poured into a mold containing fiber reinforcement, and the solution gelled in about 30 min. The gel was treated with HMDS, aged, and dried with supercritical CO₂ to obtain the aerogel. Resulting aerogels contained 10-50% of bis[3-(triethoxy-silyl)propyl]urea. The reaction is summarized as:
10% (EtO)₃—Si-Q₁-CO—O—NH-Q₂-Si-(EtO)₃+90%—[(R₃O)ₓSiO_{(4-x)/2}]ₙ—---->Gel
Where (x) is less than or equal to 1 and other variables defined in the same manner as the previous embodiments.

In one embodiment, density of the hybrid aerogels of the present invention comprise a urea or urethane linked component in greater than about 10%, greater than about 20%, greater than about 30%, or greater than about 40% by weight relative to the final aerogel material.

In another embodiment, the thermal conductivity of the hybrid aerogels of the present invention is less than about 20 mW/m·K, less than about 15 mW/m·K or less than about 10 mW/m·K, at room temperature and ambient pressures.

In another embodiment, flexural modulus of the hybrid aerogels of the present invention is greater than about 300 psi, greater than about 400 psi, or greater than about 480 psi as measured via ASTM D790.

In another embodiment, density of the hybrid aerogels of the present invention is less than about 0.3 g/cm³, less than about 0.25 g/cm³, less than about 0.2 g/cm³, less than about 0.15 g/cm³, less than about 0.1 g/cm³ or less than about 0.09 g/cm³.

It is important to note that the current embodiment can also be practiced using any concentration within the range of about 1-100% for the urea bridged alkoxysilane component. The following specific examples of the aforementioned reactions further demonstrate reactions whereby a variety of organic components are incorporated into an aerogel structure.

### EXAMPLE 1

This example illustrates the formation of a tolylene 2,4 di-ureapropyltriethoxysilane. 44.3 g of aminopropyltriethoxysilane (Commercially available from Aldrich) was added to a mixture of 17.6 g of tolylene 2,4, diisocyanate (Commercially available from Aldrich) and 61.9 g of anhydrous THF, followed by vigorous stirring at ambient temperature. The completion of this reaction can be monitored by IR spectroscopy. It was observed that the strong and narrow band at 2270 cm⁻¹ assigned to the vibration of isocyanate group of tolylene 2,4, diisocyanate disappeared at the end of the reaction (approx 1 hour).

### EXAMPLE 2

This example illustrates the formation of a 4,4 methylene bis(phenylureapropyltriethoxysilane). 44.3 g of aminopropyltriethoxysilane (Commercially available from Aldrich) was added to a mixture of 25 g of 4,4 methylenebis(phenylisocyanate) (Commercially available from Aldrich) and 69.3 g of anhydrous THF, followed by vigorous stirring at ambient temperature, until the mixture turned into a homogeneous solution. The completion of this reaction can be monitored by IR spectroscopy. It was observed that the strong and narrow band at 2279 cm⁻¹ assigned to the vibration of isocyanate group of 4,4 methylenebis(phenylisocyanate) disappeared at the end of the reaction.

### EXAMPLE 3

This example illustrates the formation of a 1,6-di(triethoxypropylurea)-hexane. 44.3 g of aminopropyltriethoxysilane (Commercially available from Aldrich) was added to a mixture of 16.8 g of 1,6-diisocyanatohexane (Commercially available from Aldrich) and 61.1 g of anhydrous THF, followed by vigorous stirring at ambient temperature. The completion of this reaction can be monitored by IR spectroscopy. It was observed that the strong and narrow band at 2262 cm⁻¹ assigned to the vibration of isocyanate group of 1,6-diisocyanatohexane disappeared at the end of the reaction (approx 1 hour).

### EXAMPLE 4

This example illustrates the formation of a isophorone-di(triethoxypropylurea). 44.3 g of aminopropyltriethoxysilane (Commercially available from Aldrich) was added to a mixture of 22.2 g of isophorone diisocyanate (Commercially available from Aldrich) and 66.5 g of anhydrous THF, followed by vigorous stirring at ambient temperature. The completion of this reaction can be monitored by IR spectroscopy. It was observed that the strong and narrow band at 2281 cm⁻¹ assigned to the vibration of isocyanate group of isophorone diisocyanate disappeared at the end of the reaction.

### EXAMPLE 5

This example illustrates the formation of a tolylene 2,4 di-ureapropyl modified silica aerogel monolith with 10 wt % loadings of organic spacer tolylene 2,4 di-ureapropyl. 20.2 g of water was added to a mixture of 42.8 g tetramethylorthosilicate (TMOS), 3.75 g of tolylene 2,4 di-ureapropyltriethoxysilane 50% THF solution (from Example 1) and 175 ml of methanol, following by mixing at ambient temperature for about 1 hour. The mixture gelled in 12 minutes after addition of a solution comprising 2.5 g of aqueous ammonia (29 wt % of ammonia) and 4.5 g of methanol. The resultant gels were first aged in ammonia/ethanol solution (4.85 wt %) at ambient temperature, followed by aging in hexamethyldisilazane (5% v/v) solution for 3 days at ambient temperature. The gels remained highly transparent after CO₂ supercritical extraction. The average thermal conductivity of the resultant aerogel monoliths was about 12.7 mW/m·K under ambient conditions, and the average density of these monoliths was 0.10 g/cm³; the three point bending test (ASTM D790) showed a 12.3 psi flexural strength at rupture.

### EXAMPLE 6

This example illustrates the formation of a fiber-reinforced form of tolylene 2,4 di-ureapropyl modified silica aerogel with 10 wt % loading of organic component tolylene 2,4 di-ureapropyl. The whole procedure was identical to that of Example 5, except the final catalyzed sol was combined with a fibrous batting and casted therein. The fiber-reinforced gel composites of this example were aged and dried following the same procedure in Example 5. The average thermal conductivity of the resultant fiber-reinforced aerogel composite was 13.1 mW/m·K under ambient conditions, with an average density of about 0.12 g/cm³.

Examples of the hybrid gels prepared using bis[3-(triethoxysilyl)propyl]urea along with their properties are listed in Table 2. Samples with target densities between 0.05 and 0.1 g/cc and urea contents from 10%-50% are described. A sample with a target density of 0.05 g/cc that was opacified with 5% carbon was also prepared. The carbon opacified sample (Target Density (TD)=0.05+Carbon opacifier content) which contained 10% of the urea had the lowest thermal conductivity and a density near 0.1 g/cc. As the results listed in Table 2 indicate, the thermal conductivities are excellent and this material is a viable candidate for cryogenic insulation.

TABLE 2
Thermal Conductivity and Densities of Hybrid Aerogels.

| | | | | | | | | | TD = 0.05 + | |
|---|---|---|---|---|---|---|---|---|---|---|
| | TD = 0.05 | | TD = 0.065 | | TD = 0.085 | | TD = 0.1 | | Carbon | |
| | TC | | TC | | TC | | TC | | TC | |
| | mW/m | ρ | mW/m | ρ | mW/m | ρ | mW/m | ρ | mW/m | ρ |
| % Urea | K | g/cc | K | g/cc | K | g/cc | K | g/cc | K | g/cc |
| 10% | 12.5 | 0.077 | 10.4 | 0.092 | 11.0 | 0.115 | 10.8 | 0.123 | 9.42 | 0.096 |
| 20% | 12.3 | 0.074 | 10.9 | 0.085 | 12.8 | 0.102 | 11.9 | 0.112 | 10.1 | 0.092 |
| 30% | 12.4 | 0.080 | 12.6 | 0.086 | 11.7 | 0.094 | 9.2 | 0.111 | 10.7 | 0.092 |
| 40% | 12.7 | 0.087 | 11.8 | 0.076 | 11.2 | 0.093 | 11.2 | 0.108 | 12.5 | 0.073 |
| 50% | 11.7 | 0.092 | 11.8 | 0.077 | 12.3 | 0.080 | 12.2 | 0.108 | 11.5 | 0.072 |

Table 3 lists the mechanical properties obtained for some urasil hybrid aerogels that were prepared and tested. Adding the ureasil compound significantly improves the mechanical properties of the aerogels as shown. The sample containing 10% ureasil has a density comparable to the sample NW112-5 but has a much higher flexural strength and modulus. Adding 10% urea gives an aerogel with a flexural strength of 22 psi at 5% strain and a flexural modulus of 485 psi (ASTM D790). Adding 50% urea decreases the density resulting in a lower modulus and a more flexible aerogel.

TABLE 3
Mechanical properties of selected aerogels and hybrid aerogels.

| | | | | Flexural | |
|---|---|---|---|---|---|
| | Wt % | Target | Actual | Modu- | |
| Sample | Fiber | Density | Density | lus | Strength at failure |
| Monolith | | 0.08 | 0.13 | 187 psi | 5 psi |
| NW114- | 9.1 | 0.08 | 0.135 | 633 psi | 23 psi (at 5% strain) |
| 10 | | | | | |
| NW112-9 | 4.7 | 0.08 | 0.135 | 442 psi | 14 psi (at 5% strain) |
| NW112-5 | 8.1 | 0.05 | 0.087 | 95 psi | 5 psi (at 5% strain) |
| 10% urea | | 0.065 | 0.092 | 485 psi | 22 psi (at 5% strain) |
| 50% urea | | 0.065 | 0.077 | 147 psi | 7 psi (at 5% strain) |
| Airex | | | 0.06 | 4784 psi | 180 psi (at 5% strain) |
| R82.60 | | | | | |

The pore size distribution of the six hybrid aerogels prepared from condensing bis[3-(triethoxysilyl)propyl]urea with a silica precursor were determined. For all the samples, the average pore size was centered around 14 nm and the surface area varied from 791 to 900 m²/g.

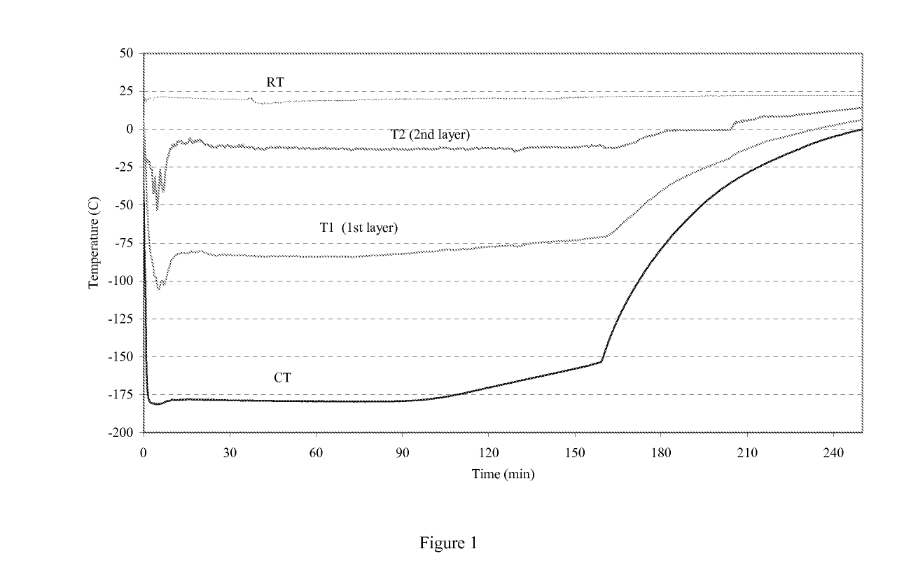

Thermal property of the urea hybrid aerogels described herein for applications involving cryogenic insulation have been tested. Two layers of aerogel were wrapped around a container of liquid nitrogen, where the cold side temperature was −180° C. The temperatures between the two layers was measured as illustrated in FIG. 1, and it was determined that approximately ½ inch of aerogel was sufficient to provide a surface temperature of −12° C. Based on published results, a similar thickness of polyimide ether cryofoam would be expected to have a surface temperature of around −80° C. Based on this test, the aerogel is expected to be a significantly better cryogenic insulation material than many of the organic foams.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method of incorporating at least one organic component into a porous silica material comprising the steps of:
a) reacting a first organoalkoxysilane comprising at least one isocyanate group with a second organoalkoxysilane comprising at least one reactive amine group, such that a urea group is formed linking both said first and second organoalkoxysilane and resulting in a urea bridged compound; further wherein said first, second or both organoalkoxysilanes comprise at least one organic component other than a urea or amine;
b) reacting the urea bridged compound with a silica precursor thereby forming a gel network with said organic component covalently bonded therein; and
c) drying said gel thereby obtaining an aerogel material.

2. The method of claim 1 wherein the gel is dried with a supercritical fluid.

3. The method of claim 1 where said silica precursor is an alkylalkoxysilane, ethylpolysilicate, tetraethylorthosilicate (TEOS), tetramethylorthosilicate (TMOS), partially hydrolyzed TEOS, partially hydrolyzed TMOS or a combination thereof.

4. The method of claim 1 wherein the organoalkoxysilanes are organotrialkoxysilanes

5. The method of claim 4 wherein said organotrialkoxysilanes are organotriethoxysilanes.

6. The method of claim 1 wherein the urea bridged compound is tolylene 2,4 di-ureapropyltriethoxysilane, 4,4 methylene bis(phenylureapropyltriethoxysilane), 1,6-di(triethoxypropylrea)-hexane, isophorone-di(triethoxypropylurea) or tolylene 2,4 di-(triethoxysilylpropylurea).

7. The method of claim 1 comprising an olefinic compound, aliphatic compound, arylenic compound, acetylenic compound, organometallic compound, coordination compound, or a combination thereof.

8. The method of claim 1 further comprising the step of combining the product of step a) with a fibrous structure.

9. The method of claim 8 wherein the fibrous structure comprises microfibers, mats, felts, woven fabrics, non-woven fabrics, fibrous battings, lofty battings or a combination thereof.

10. The method of claim 1 comprising the step of incorporating additives in the gel before drying thereof.

11. The method of claim 10 wherein the additives comprise organic or inorganic fillers, antioxidants, fibers, infrared opacifiers, flame retardants, smoke suppressants, oxidation catalysts or combinations thereof.

12. The method of claim 11 wherein the opacifiers comprise: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide, chromium oxide, silicon carbide and any combination thereof.

13. The method of claim 1 wherein the aerogel material comprises greater than 10% of the urea bridged compound by weight.

14. The method of claim 1 wherein the aerogel material comprises greater than 40% of the urea bridged compound by weight.

15. The method of claim 1 wherein the aerogel material has a thermal conductivity of less than about 15 mW/m·K at room temperature and ambient pressure.

16. The method of claim 1 wherein the aerogel material has a flexural modulus greater than about 480 psi.

17. The method of claim 1 wherein the aerogel material has a density less than about 0.1 g/cm³.

18. (canceled)

19. (canceled)

20. An aerogel material manufactured according to claims 1.

21. A method of incorporating at least one organic component into a porous silica material comprising the steps of:
a) reacting a first organoalkoxysilane comprising at least one isocyanate group with a second organoalkoxysilane comprising at least one reactive hydroxyl group, such that a urethane group is formed linking both said first and second organoalkoxysilane and resulting in a urethane bridged compound; further wherein said first, second or both organoalkoxysilanes comprise at least one organic component other than a hydroxyl or amine;
b) reacting the urethane bridged compound with a silica precursor thereby forming a gel network with said organic component covalently bonded therein; and
c) drying said gel thereby obtaining an aerogel material.

22. The method of claim 21 wherein the gel is dried with a supercritical fluid.

23. The method of claim 21 where said silica precursor is an alkylalkoxysilane, ethylpolysilicate, tetraethylorthosilicate (TEOS), tetramethylorthosilicate (TMOS), partially hydrolyzed TEOS, partially hydrolyzed TMOS or a combination thereof.

24. The method of claim 21 wherein the organoalkoxysilanes are organotrialkoxysilanes

25. The method of claim 21 wherein said organotrialkoxysilanes are organotriethoxysilanes.

26. The method of claim 21 comprising an olefinic compound, aliphatic compound, arylenic compound, acetylenic compound, organometallic comopund, coordination compound, or a combination thereof

27. The method of claim 21 further comprising the step of combining the product of step a) with a fibrous structure.

28. The method of claim 21 wherein the fibrous structure is microfibers, mats, felts, woven fabrics, non-woven fabrics, fibrous battings, lofty battings or a combination thereof.

29. The method of claim 21 further comprising the step of incorporating additives in the gel before drying thereof.

30. The method of claim 29 wherein the additives comprise organic or inorganic fillers, antioxidants, fibers, infrared opacifiers, flame retardants, smoke suppressants, oxidation catalysts or combinations thereof.

31. The method of claim 30 wherein the opacifiers comprise: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide, chromium oxide, silicon carbide and any combination thereof.

32. The method of claim 21 wherein the aerogel material comprises greater than 10% of the urea bridged compound by weight.

33. The method of claim 21 wherein the aerogel material comprises greater than 40% of the urea bridged compound by weight.

34. The method of claim 21 wherein the aerogel material has a thermal conductivity of less than about 15 mW/m·K at room temperature and ambient pressure.

35. The method of claim 21 wherein the aerogel material has a flexural modulus greater than about 480 psi.

36. The method of claim 21 wherein the aerogel material has a density less than about 0.2 g/cm³.

37. (canceled)

38. (canceled)

39. An aerogel material manufactured according to claims 21.
